(19) United States
(12) Patent Application Publication
(10) Pub. No.: US 2017/0255012 A1
(43) Pub. Date: Sep. 7, 2017

(54) HEAD MOUNTED DISPLAY USING SPATIAL LIGHT MODULATOR TO MOVE THE VIEWING ZONE

(71) Applicant: Sharp Kabushiki Kaisha, Osaka (JP)

(72) Inventors: Ka Ho Tam, Oxford (UK); David James Montgomery, Bampton (GB); Tim Michael Smeeton, Oxford (UK)

(21) Appl. No.: 15/060,957

(22) Filed: Mar. 4, 2016

(51) Int. Cl. G02B 27/01; G06F 3/01

(52) U.S. Cl. CPC G02B 27/0172; G02B 27/0179; G06F 3/013; G02B 2027/0187

(57) ABSTRACT

A wearable device includes a light source and a display unit. The display unit includes an image engine that controls the light source to generate image content for display, and a plurality of optical elements that direct the image content into a viewing zone. An eye monitor measures information pertaining to an eye configuration of a user wearing the wearable device, and the image content is visible to the user when the eye is aligned with respect to the viewing zone. A spatial light modulator (SLM) moves a position of the viewing zone based on the eye configuration information measured by the eye monitor. The eye monitor measures pupil size of the user, and the optical elements direct the image content into the viewing zone that is smaller in at least one dimension than twice the measured pupil size. The light source may include a micro-electro-mechanical systems (MEMS) scanning mirror.

### TECHNICAL FIELD

The invention has application within the field of wearable displays. It is used for achieving a light weight design in head mounted displays.

### BACKGROUND ART

Head-Mounted-Displays (HMD) is a type of device with increasing popularity within the consumer electronics industry. HMDs, along with similar devices such as helmet-mounted displays, smart glasses, and virtual reality headsets, allow users to wear a display device such that the hardware remains fixed to their heads regardless of the person's movement.

When combined with environmental sensors such as cameras, accelerometers, gyroscopes, compasses, and light meters, HMDs can provide users with experiences in virtual reality and augmented reality. Virtual reality allows a user to be completely submerged into a virtual world where everything the user sees comes from the display device. On the other hand, devices that provide augmented reality allow users to optically see the environment. Images generated by the display device are added to the scene and may blend in with the environment.

One of the primary elements of HMDs is a display module mounted onto the head. However, since the unaided human eye cannot accommodate for images closer than a certain distance from the eye, eye piece lenses are required to re-image the display module such that the display appears to be at a comfortable viewing distance from the user. Such optical configuration requires lots of space between the eye piece and the display module. Furthermore, complex lenses are needed if the HMD needs to display images with high quality and wide field of view. These lenses often make the device very bulky to wear.

A number of methods had been invented to eliminate the need of heavy lenses in HMDs. Light field displays use a high resolution image panel with a microlens array to integrate subsets of images onto different parts of the retina. This method leads to images with low effective resolution. Retinal scanning displays are capable of producing images with resolution equivalent to the native resolution of the laser scanner. However, the stringent requirement to align the scanning mirror through the eye's pupil means that it is very difficult to fabricate an HMD that fits different anthropometric variations.

WO9409472A1 (Furness et al., published Apr. 28, 1994), WO2015132775A1 (Greenberg, published Sep. 11, 2015), U.S. Pat. No. 8,540,373B2 (Sakakibara et al., issued Mar. 31, 2011), JP2013148609A (Pioneer, published Jan. 8, 2013, and JP5237267B2 (Yamamoto, issued Jul. 17, 2013) describe representative retinal scanning displays where a collimated beam and scanning mirrors are used to directly rasterize an image onto the retina. These devices include a gaze tracker which determines the gaze direction of the eye. Apart from the scanning mirrors that rasterizes the image, additional mechanical mirrors are used to move the eye point of the optical system depending on eye position obtained from a gaze tracker.

These systems suffer from a number of problems. Firstly, the mechanical mirror used to steer the eye points either needs to be large, or relay optics will be required to form intermediate images of the raster mirror, both of which will lead to a bulky device. Secondly, large mechanical mirrors could have problems with durability if they are mounted into compacted consumer portable devices as they will need to withstand regular shocks and other physical abuses. Thirdly, these systems require a gaze tracker to pinpoint the eye's position accurately. Inaccurate gaze tracking may cause the eye point to miss the eye's pupil, rendering these devices useless.

WO2014155288A2 (Tremblay et al., published Oct. 2, 2014), and CN103837986A (Hotta et al., published Jun. 4, 2014) describe retinal direct projection displays with multiple exit pupils. The exit pupils are at different lateral positions. The device operates normally when the eye intercepts exactly one of these exit pupils. However, because these exit pupils are at fixed locations, the display will only function if the user's pupils have a fixed size and are located at a fixed distance from the display. If the eyes are at the wrong distance from the display, or if the eye's pupils are the wrong size, the eyes will intercept multiple or no exit pupils. This may result in blurry or flickering images as the user moves his eyes.

IDW 14 PRJ4-1 (Masafumi Ide, et al., “Laser Light Field Display Based on a Retinal Scanning Array”, IDW 2014) describes a laser scanning HMD with multiple exit pupils. The device works on a similar principle to light field displays. A different image is displayed through each element of the lens array. The eye intercepts more than one of these images. Each of these images is formed on different parts of the retina with regions where the images overlap. However, this system requires resolution splitting, resulting in a small field of view (FoV) leading to low effective image resolution.

WO2012062681A1 (Fuetterer, published May 18, 2012) describes a HMD where a spatial light modulator (SLM) is used to temporal and spatially multiplex several holograms to increase the field of view of the display. The SLM rapidly changes the apparent location of the hologram temporally in order to display a larger image. However, such device will still require large eyepiece lenses between the SLM and the eye, making the device bulky.

### SUMMARY OF INVENTION

This invention concerns a design of a wearable display which enables the device to have reduced weight relative to known configurations without compromising other technical performances. The design is particularly suitable for a head mounted display or smart glasses with applications in virtual reality (VR) and augmented reality (AR). The principle element of the design involves the use of a spatial light modulator (SLM) to move the viewing zone of the system.

The invention is a display system which includes one or more light sources with high spatial coherence, a display unit, an eye monitor, and a spatial light modulator. The display unit may include an image engine and a plurality of fixed optical elements. The components are arranged in a geometry that can be fitted into a compacted head wear and allow the user to comfortably see a clear image without the need of bulky eyepiece lenses or large relay optics. The HMD system of concern also has a small viewing zone, where the user's eyes must be placed precisely within this zone in order for an image to be visible. Depending on the shape of the viewing zone, they may also be referred to as “eye points”, where the viewing zone is small or “eye boxes”, where the viewing zone is larger than the eye pupil in at least one dimension, in several embodiments, and generally is smaller in at least one dimension than twice the measured pupil size.

The first and second exemplary embodiments of the present invention include a display device which includes a display unit, a Spatial Light Modulator (SLM), and an eye monitor. The display unit further includes a laser Micro-Electro-Mechanical Systems (MEMS) scanning projector with a number of fixed optical elements.

The MEMS projector uses a number of lasers as a light source, where the intensity of the scanning lasers are temporally modulated by the image signal of the display, and the MEMS mirror rasterizes the image in space by oscillating at a high frequencies. The projector is followed by fixed optical elements, which produces one or more real images of the MEMS mirror. These real images are the exit pupil of the optical system defining the HMD's viewing zone.

The SLM is placed along the optical path between the MEMS mirror and the viewing zones. The function of the SLM is to move the position of the viewing zones based on information obtained from the eye monitor.

The SLM can be made from any technologies from the known art such as liquid crystal panels, liquid crystal on silicon (LCoS) panels, electrowetting panels, and pixelated MEMS mirror arrays, or where the element can steer light using refractive, gradient index (GRIN) refractive, diffractive, or reflective principles.

Because the viewing zone (exit pupil) of the system is steered by an SLM instead of mechanical mirrors, no intermediate images of the viewing zone (exit pupil) are formed, eliminating the need of bulky relay optics or large space for viewing zone steering mirrors. SLMs are also more durable than large mechanical mirrors and are more resistant to shocks—something wearable devices are frequently subjected to. In addition, in cases where the system has multiple viewing zones, the SLM could be used to change the separation between these viewing zones depending on information such as size of the pupil, image content, and the real time reliability of gaze tracking. No intermediate images of the full display are formed in the system. This is achieved by projecting the image directly onto the user's retina in these two specific examples.

Subsequent embodiments describe the possible use of SLMs to move the viewing zones in other HMD arrangements.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1: The first embodiment of this invention including a HMD.

FIGS. 2(a) and 2(b): Illustrates the use of SLMs to shift the viewing zone laterally in a retinal scanning system according to the first embodiment, including:

FIG. 2(a): SLM switched off.

FIG. 2(b): SLM steers the viewing zone of the system off-axis.

FIGS. 3(a)-3(c): Illustrates the use of SLMs to shift the viewing zone axially in a retinal scanning system according to the primary embodiment, including:

FIG. 3(a): SLM switched off while the user gazes forward.

FIG. 3(b): The user gazes upwards.

FIG. 3(c): SLM moves the viewing zone axially towards the pivot of the eye.

FIGS. 4a, 4b, and 4c: Second embodiment. Shows how an SLM can be used to move or merge multiple eye points in a multiple eye point retinal scanning HMD.

FIG. 5: Shows the laser beam divergence angles in the second embodiment.

FIGS. 6(a) and 6(b): Third embodiment. Showing the use of SLMs to shift the position of viewing zones in a light field system depending on the eye position of the user, including:

FIG. 6(a): Viewing zone close to the image panel.

FIG. 6(b): Viewing zone shifted further away from the image panel.

FIGS. 7(a) and 7(b): Fourth embodiment. Illustrates a HMD system where the image is produced by sets of 1D hologram images. A single-axis MEMS scanner is used to rasterize these line-holograms onto different regions of the retina. An SLM is used to steer the light beam in one dimension, including:

FIG. 7(a): y-z view of the system

FIG. 7(b): x-z view of the system FIG. 8: Trimetric view of the forth embodiment.

FIG. 9: Fifth embodiment. Showing the use of SLM to time multiplex several eye points in an HMD.

FIG. 10: Sixth embodiment. Use of an axicon to generate a Bessel beam in a MEMS projector. Self-healing properties of the beam reduces artifacts produced by the pixel structure of the SLM.

FIG. 11: Seventh embodiment. Shows the use of SLM to move the eye point of a retinal scanning system where the light source is a highly collimated LED.

FIG. 12: Eighth embodiment, where the SLM is curved in order to improve optical performance.

FIG. 13: Ninth embodiment, where the SLM is used to steer the eye point in a retinal scanning HMD with multiple laser scanners.

FIGS. 14a-b: Tenth embodiment, where the addition of a small SLM is used to periodically displace a laser beam to create a dithered image on the retina for improved image resolution.

FIG. 14(a): Shows the configuration of the HMD with the small SLM

FIG. 14(b): Shows the paths of the displaced raster lines of a laser beam on the retina over one image frame.

### DESCRIPTION OF REFERENCE NUMERALS

1: Laser
2: Scanning Mirror
3: Fixed optical elements
4: SLM
5: Retina of the eye
6: Point image on the retina
7: Eye monitor
8: Eye Point/Viewing Zone (real image of the MEMS mirror), not shifted by SLM.
9: Eye Point/Viewing Zone (real image of the MEMS mirror), laterally shifted by SLM.
10: Fovea of the eye
11: Path of laser beam truncated by the iris of the eye.
12: Eye Point/Viewing Zone (real image of the MEMS mirror), axially shifted by SLM to coincide with the pivot of the eye.
13: Image engine
20: Lens array according to the second embodiment
21: SLM, as described in the second embodiment
22: (a-c) Multiple eye points/viewing zones, unshifted by SLM
23: (a-c) Multiple eye points/viewing zones, shifted by SLM to become closely spaced.
24: Merged single Eye point/viewing zone
30: Image engine according to the third embodiment
31: Fixed optics lens array according to the third embodiment
32: SLM according to the third embodiment
40: Single axis MEMS mirror according to the forth embodiment.
41: Diffractive element according to the forth embodiment.
42: Astigmatic optics according to the forth embodiment
43: SLM/Image panel according to the forth embodiment
44: SLM according to the forth embodiment
45: Eye box according to the forth embodiment
50: (a-c) Eye points at different time sequence according to the fifth embodiment.
51: SLM as described in the fifth embodiment.
60: Laser beam according to the sixth embodiment.
61: Aperture according to the sixth embodiment.
62: Axicon optics according to the sixth embodiment.
63: MEMs scanning mirror according to the sixth embodiment.
64: Non-diffracting zone according to the sixth embodiment.
70: LED according to the seventh embodiment.
71: Collimation optics according to the seventh embodiment.
80: Curved SLM according to the eighth embodiment.
90: (a-b) multiple MEMS scanner according to the ninth embodiment.
100: SLM/switchable retarder according to the tenth embodiment.
101: a) Scanning lines in odd frames according to the tenth embodiment.
   b) Scanning lines in even frames according to the tenth embodiment.
200: Laser beam waist/path at an infinitesimal moment.
201: Deflection angle of SLM
202: Default distance from the HMD to the eye point.
203: Shifted distance from the HMD to the eye point.
204: (a-d) Laser beam divergence at various stages of the optical system according to the second embodiment.
205: Laser beam waist at the eye's pupil.
206: (a-b) Distance from the image panel to the viewing zone according to the third embodiment.
207: (a-b) Size of the viewing zone in a LF system.

### DETAILED DESCRIPTION OF INVENTION

An aspect of this invention is a head mount display or similar display devices that are fixed to the head. In exemplary embodiments, the display device includes a display unit, an eye monitor, and a spatial light modulator unit. The display unit may include an image engine and a plurality of fixed optical elements. The display unit is characterized by a finite viewing zone which can be comparable to or smaller than the dimensions of the eye pupil, and generally may be smaller in at least one dimension than twice the measured pupil size. The user's eyes must be within this viewing zone for images to be visible. The spatial light modulator is used to change the position of these viewing zones according to information obtained from the eye monitor.

### 1^{st} Embodiment

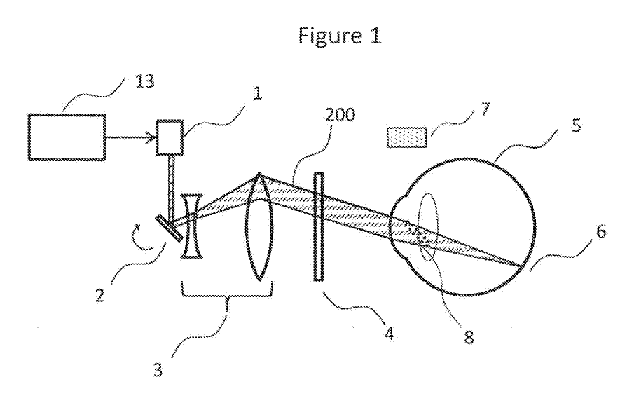

The first embodiment of this invention is shown in FIGS. 1-3. The device is a head mounted display. In exemplary embodiments, the head mount display is a wearable device that includes a light source and a display unit. The display unit includes an image engine that controls the light source to generate image content for display, and a plurality of optical elements configured to direct the image content into a viewing zone. An eye monitor measures information pertaining to an eye configuration of a user wearing the wearable device, wherein the image content is visible to the user when the eye is aligned with respect to the viewing zone. A spatial light modulator (SLM) is configured to move a position of the viewing zone based on the eye configuration information measured by the eye monitor.

FIG. 1 shows the device's main components at one moment in time. This embodiment's system includes a laser 1, scanning mirror 2, several fixed lenses 3, a spatial light modulator 4, and an eye monitor 7. The laser 1 could be a combination of red, green, and blue lasers. The intensity of each laser is temporally modulated by an image signal of a display image that is generated by an image engine 13 to generate image content. However, different color combinations or different numbers of high coherence light sources can also be used in place of the lasers. The scanning mirror 2 is based on Micro-Electro-Mechanical Systems (MEMS) which is capable of rapid oscillation about two axes. The mirror's scanning movement is in synchronization with the rows or columns of the image signal and out couples a laser beam that time sequentially scans in two dimensions. However, other known mechanisms for scanning a laser beam, such as the use of two single axis scanning mirrors or acousto-optic scanners, can also be used in place of the MEMS mirror.

The laser beam passes through a number of fixed optical elements 3 and a spatial light modulator (SLM) 4. The fixed optical elements create a real image of the scanning mirror in space 8, which depicts an eye point/viewing zone not shifted by the SLM. This real image is the exit pupil of the HMD, which also defines the viewing zone. The optical elements 3 are arranged such that the instantaneous laser beam waist 200 remains collimated or slightly divergent at the viewing zone. Here, the divergence of the instantaneous beam needs to be small such that the eye can accommodate for the beam and form a small point image 6 on the retina 5. A small beam spot on the retina would allow an image with high display resolution to be directly projected onto the retina. Although the figure depicts the optical elements 3 as a negative lens followed by a positive lens for the sake of simplicity in explanation, other combinations of known optical elements could also be used in order to achieve better beam quality, image quality, and compactness. This includes the use of compound lenses, free form lenses, diffractive lenses, reflective elements, and Fresnel lenses.

Without a loss of generality, the optical element 3 may also be a flat element utilizing a waveguide/light guide type backlight with the use of known extraction methods to produce a converging/directional beam. The flat element can be illuminated with a laser or LED light source or projection system for time sequential operation. The backlight and SLM panels can form the basis of a flat modular arrangement, in which each component includes a layer of a stack. The advantage of this approach is that the display is then thin and lightweight and could be incorporated into an eye unit no larger than a pair of spectacles.

The SLM 4 in the preferred embodiment is a transparent pixilated liquid crystal panel (LCD) with a high pixel density, capable of providing phase and/or amplitude modulation to the laser beam 200. However, other known technologies for achieving spatial light modulators could also be used. This includes reflective LCDs, liquid crystal on silicon (LCoS), MEMS mirror arrays, and electrowetting panels. The SLM could be pixel addressable and is used to change the direction of an incoming laser beam through refractive, gradient index (GRIN) refractive, diffractive, or reflective mechanisms.

An eye monitor 7 in the system monitors the conditions of the eye to measure information pertaining to an eye configuration of a user wearing the wearable device. The eye monitor in the preferred system is an optical gaze tracker and many include a camera and an infrared light source. The eye monitor could be capable of obtaining eye configuration information of the eye such as gaze direction, pupil diameter, and distance of the eye from the SLM of the HMD. However, eye monitors based on other known technologies for monitoring the eye such as electrooculography gaze trackers could also be used.

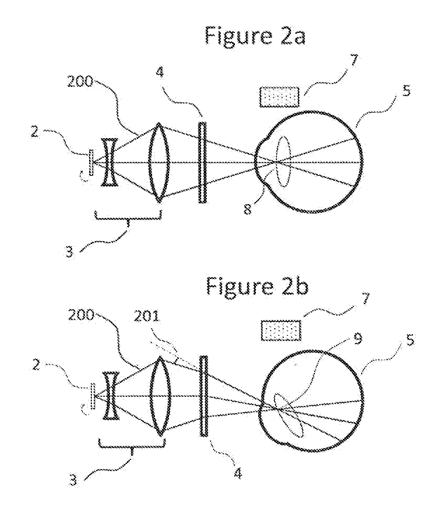

FIGS. 2a-b show the operation of the first embodiment. The laser beam path at an infinitesimal moment 200 is now depicted as a single line rather than a hatched area, where each of these lines shows the paths of the scanned laser beam over the duration of one image frame. FIG. 2a shows the default beam paths while the eye gazes directly forward. All the laser beam paths during an image frame converge at a single default eye point 8. The image content is visible to the user when the eye generally is aligned with respect to the viewing zone. To achieve such alignment, this eye point should coincide with the eye's pupil to achieve maximum field of view. For example, to correlate the viewing zone with the pupil to optimize the field of view, in exemplary embodiments the viewing zone may be smaller in at least one dimension than twice the measured pupil size. FIG. 2b shows the HMD's operation when the eye rotates. Since the pivot point of the eye differs from the location of the pupil, rotating the eye would cause the eye's pupil to be misaligned from the default eye point. Under this situation, the SLM is switched to steer the eye point at a deflection angle 201 to the new location of the pupil, eye point 9, based on eye configuration information obtained from the gaze tracker 7.

The information projected onto the retina will be seen by the viewer as having a fixed location in space relative to the head but not to the eye, so that a “natural” reproduction of the spatial information in keeping with the human expectation of the image as the eye and head moves will be obtained. This will result in reduced headaches and other negative human responses to this type of HMD technology than in the prior art.

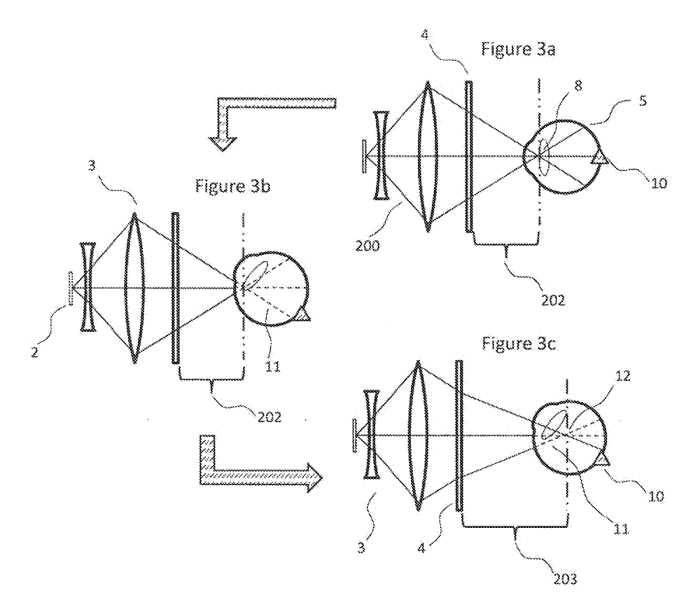

FIGS. 3a-c show a different operation mode of the first embodiment under circumstances where the gaze tracker is unreliable. FIG. 3a shows the default position of the eye point when the user gazes directly forward. In this case, the eye point is at a default distance 202 from the SLM 4. However, with current technology, the gaze tracker may occasionally suffer from latency problems or may not be able to accurately determine the position of the user's eye. This could lead to lateral misalignment between the eye point and the pupil as shown in FIG. 3b, causing the image to disappear as indicated by the rays truncated by the pupil 11 (dashed line). To overcome this, the gaze tracker could return additional parameters such as the error value of eye tracking. If the error is too high, the SLM could displace the eye point axially to a shifted distance 203 to a position closer to the pivot of the eye 12 shown in FIG. 3c. While this operation mode may reduce the visible FoV of the image, an image will remain visible near the eye fovea 10 in different gaze directions. Complications such as image distortion caused by the shifting of the eye point could be compensated by known image processing methods.

It should be mentioned that these two schemes for shifting the eye point laterally (FIG. 2a-b) and axially (FIG. 3a-c) are not mutually exclusive and can be used simultaneously with each other. In other words, the advantage of using an SLM over mechanical mirrors is that an SLM could move the eye point to arbitrary positions within a 3D volume.

Subsequent embodiments in this description will be made in reference to the first embodiment and only the differences between the subsequent embodiments and the first embodiments will be discussed.

### 2^{nd} Embodiment

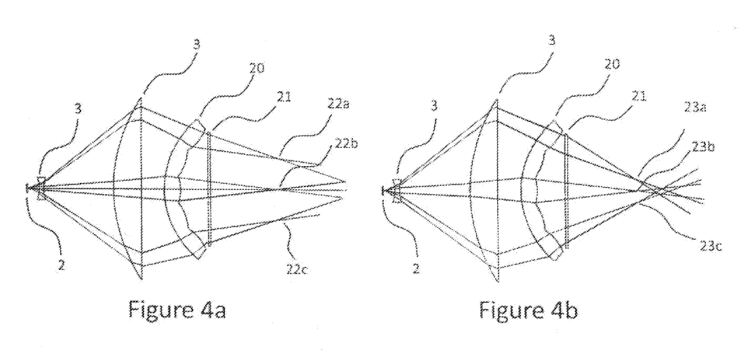

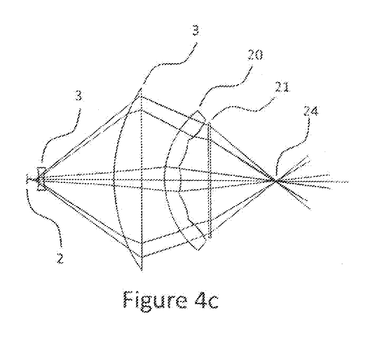

The second embodiment is shown in FIGS. 4a-c, where lens array 20 including a plurality of lenslets is added to the system. FIG. 4a shows the HMD functioning as a multiple eye point retinal scanning system. Each lenslet from the lens array creates a separate eye point (22a-c) unshifted by the SLM 21 in FIG. 4a. In other words, each lenslet in the array directs the image content into a separate eyepoint corresponding to a respective viewing zone. An image will be visible as long as the user's pupil is placed at or aligned with one of these eye points. The inclusion of the SLM 21 not only makes the system capable of moving a single eye point, but could also change the position of individual eye points.

When combined with eye configuration information obtained from the eye monitor, the separation between these eye points can be varied to accommodate for the varying pupil size of users such that only one eye point enters the eye at any time. For example, if a user wears the HMD immediately after coming from bright sunlight environment, his eyes would have a small pupil. This would be detected by the eye monitor in the HMD, and the separation of the eye points could be reduced accordingly as shown in 23a-c in FIG. 4b.

FIG. 4c shows an alternative mode of operation of the second embodiment, where the SLM reduces the separation of these eye points so much, that more than one eye point enters the user's pupil simultaneously. These eye points 24 could even become merged together to create an image with large FoV and high resolution. The images originated from each eye point may or may not overlap on the retina. This mode of operation will be useful when the gaze tracker is reliable.

The separation of these eye points are variables which could be adaptive based on a number of factors such as the user's pupil size, distance of the eye from the HMD, image content currently being displayed, latency of the gaze tracker, and the accuracy of gaze tracker.

A multi-eye point HMD with variable eye point separation offers several advantages. Firstly, various eye points' separation could be adaptive for different pupil diameters of different users, reducing the risks of image flickering and blurring due to none or more than one of the eye points entering the eye.

Secondly, using an SLM in the HMD would allow real time trade-off between field of view, image quality, and the requirement of gaze tracking accuracy. For example, if the HMD is displaying a moving object, the accuracy of the gaze tracker may be poor due to rapid movement of the eye. In this case, the SLM could be programmed to create multiple eye points as in FIG. 4a-b. However, if the HMD is displaying a still image, there is expected little eye movement. In this case, the gaze tracker would be able to accurately determine the gaze direction of the eye. Hence the alternative scheme FIG. 4c may be used to create a single eye point with high resolution and large FoV.

Thirdly, since most SLM technologies are known to exhibit inferior performance at large beam steering angles, image quality in a multiple eye point system could be better than a single eye point system. This is because a multiple eye point system would not be required to steer light over the full range of the eye's movement.

Although the use of a lens array was used for creating multiple eye points, the lens array may not be necessary if the SLM already possesses sufficiently high resolution to replicate the effect of the lens array.

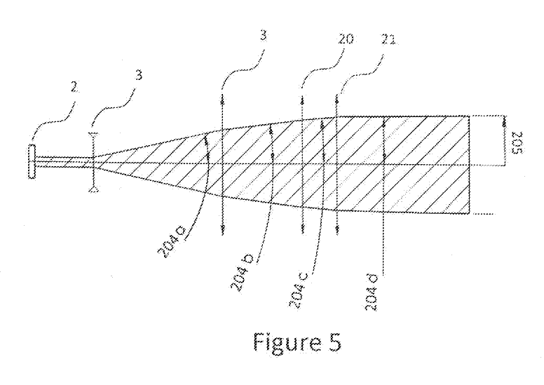

FIG. 5 shows one possibility of the laser beam waist and divergence angle (204a-d) at various stages of the system. In order for a high resolution image to be formed on the retina, the beam waist 205 at divergence 204d of the laser beam at the pupil will be crucial. The laser will need to be diverging with an angle small enough for the eye to accommodate; whereas the beam waist needs to be large enough in order for it to be focused down to a small spot size on the retina.

### 3^{rd} Embodiment

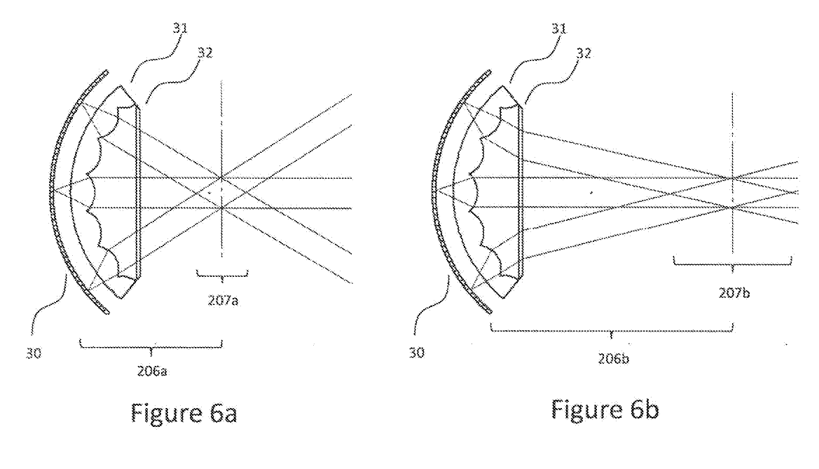

FIGS. 6a-b shows the third embodiment where an SLM is employed in a light field HMD. FIG. 6a shows a light field HMD which includes an SLM 32 and a display unit. The display unit further includes an image engine 30 and fixed optics 31. The display engine 30 is an OLED screen but may also be any pixelated image display panels such as an LCD display. The fixed optics may be configured as a lens array. The light field HMD has a finite viewing zone 207a where the full image is only viewable when the eye is placed within this zone. Depending on the ergonomics of the user, it is likely that his eyes will not be placed in the optimal position of the zone. Hence the SLM can be used to change the location or distance from the image panel (206a-b) and size (207a-b) of this viewing zone depending on the eye configuration information obtained from the eye monitor.

### 4^{th} Embodiment

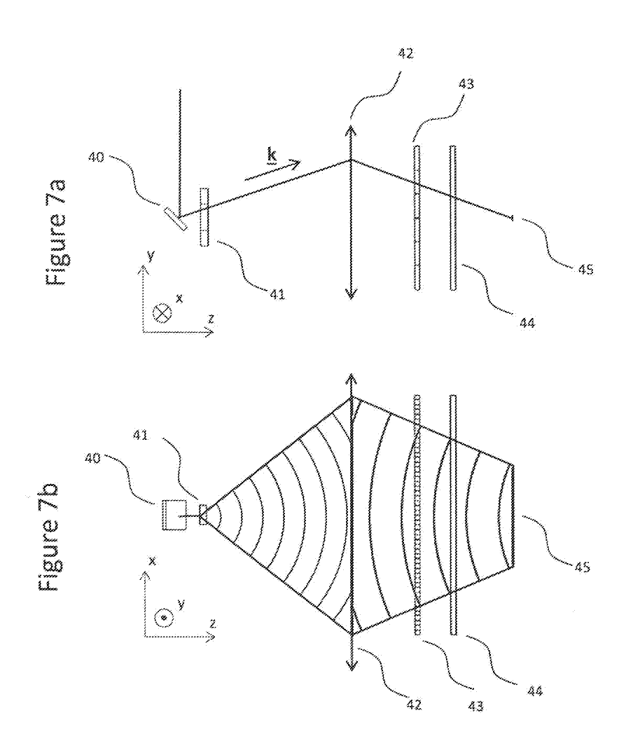

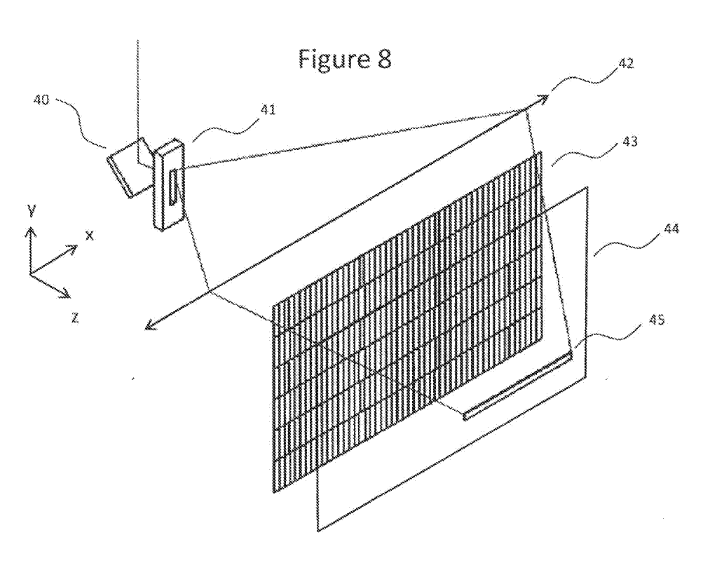

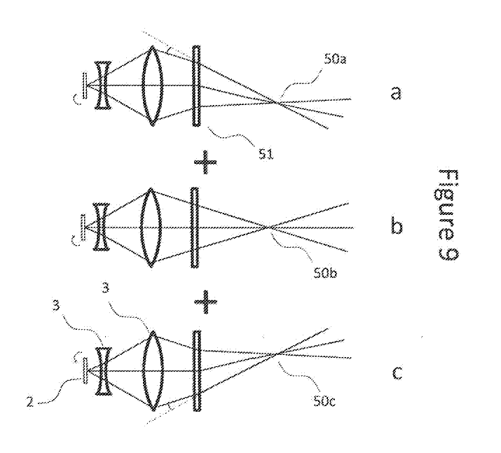

FIGS. 7a-b and FIG. 8 show the fourth embodiment where an SLM is used in a one dimensional retinal scanning system. FIGS. 7a-b show the side and top view of the system respectively, whereas FIG. 8 shows the trimetric view of the same embodiment. The system includes a single-axis MEMS scanning mirror 40 which rasterizes an image in one dimension; a diffractive element 41 which creates a beam diverging coplanar to both the rotating axis of the MEMS mirror x and the propagation direction k; an astigmatic optics 42 which could include multiple fixed optical elements; an image engine or panel 43 which could be an LCD; and an SLM 44 to steer light about the same axis x as the rotation of the MEMS mirror.

The image panel 43 is an LCD which has a high pixel density in one dimension x and can have a low pixel density in the other dimension y. The image displayed on the LCD is synchronized with the scan angle of the MEMS mirror.

The image panel displays a pattern where the x-axis is the one dimensional mathematical transform of the image, and the y-axis has not undergone the mathematical transformation. The mathematical transformation is Fourier Transform but could also be other known algorithms for generating holograms. The panel creates a line hologram parallel to the x-axis. The MEMs mirror rotates about the x-axis and rasterizes multiple line holograms along the y dimension. To obtain high resolution images along the y-axis, the LCD 43 will need to update several times per frame. Such fast update speed could be achieved with known technologies such as ferroelectric or blue phase liquid crystal panels.

This system creates a rectangular viewing zone 45 configured as an eye box with a long dimension along x and a short dimension along y. The long dimension is the eye box size of the line hologram and the short dimension is the eye box size of the retinal scanning system.

The SLM 44 is an LCD which serves a similar purpose as the SLM 4 in the first embodiment. It is used to move the eye box towards the user's pupil based on the gaze tracker's information. However, the SLM 44 here would only be required to deflect light in one dimension about the x-axis.

In other words, the embodiment is essentially a HMD which appears as a retinal scanning system along the y-z plane and a holographic display along the x-z plane. The long eye box 45 of the HMD means that eye tracking and light steering would only be needed in one dimension. This would enable a simpler construction of the SLM and the eye tracker.

Although a specific configuration has been given, the SLM described in this embodiment could be applied to other HMD systems where the eye box is long and narrow, with the SLM is capable of steering light along the narrow direction of the eye box. In exemplary embodiments, the viewing zone formed by the eye box generally is smaller in at least one dimension than twice the measured pupil size.

### 5^{th} Embodiment

FIGS. 9a-c show the fifth embodiment where multiple eye points 50a-c are created by temporal multiplexing using a rapidly switching SLM 51. The SLM in this embodiment switches between several different amplitude or phase patterns within each image frame to create multiple eye points in space that each correspond to a respective viewing zone. The SLM is switched to move one or more of the eyepoints and/or vary separation of the eyepoints based on the eye configuration information measured by the eye monitor.

The functions and advantages of a multiple eye point system have already been described in the second embodiment. However, since lens arrays are not needed in the current embodiment, the current embodiment offers additional advantages in construction costs and weight.

### 6^{th} Embodiment

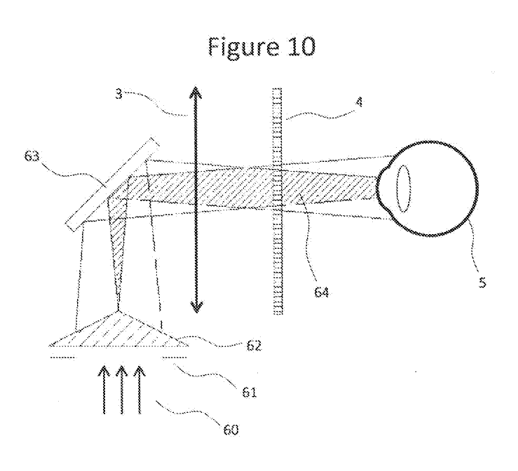

FIG. 10 shows the sixth embodiment where a Bessel beam is used in the retinal scanning system. In this embodiment, axicon optics 62 is added to the system before the MEMS scanning mirror 63. An axicon is a known specialized type of lens which has a conical surface. A laser beam 60, which could be a Gaussian beam, is incident onto the axicon 62 through an optional aperture 61. The laser beam coming out from the axicon is a Bessel beam which has a non-diffracting zone 64 within a limited distance from the axicon. At the MEMS mirror, the diameter of the Bessel beam needs to remain smaller than the mirror to avoid diffraction artifacts. The Bessel beam passes through a number of fixed optics 3 and remains non-diffracting when it reaches the SLM 4.

Bessel beams are known to be self-healing, meaning that the beam can be partially obstructed but will reform further down the beam axis. Hence the use of a Bessel beam could reduce diffraction artifacts or speckles caused by pixel structure of the SLM. Although an axicon is used to generate the Bessel beam in this embodiment, other known beam shaping techniques, such as the use of diffractive elements can also be used. Beam shapes other than Bessel beams which are known to complement diffraction through pixel structure of the SLM could also be used.

### 7^{th} Embodiment

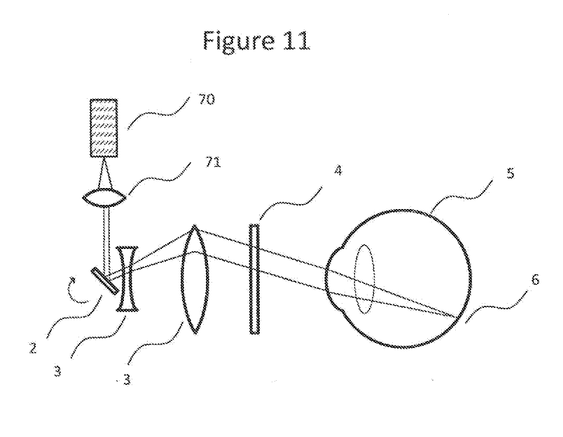

FIG. 11 shows the seventh embodiment, wherein an LED (light emitting diode) with high spatial coherence 70 and a collimation lens 71 is used in place of the laser. The collimation lens 71 could be a fixed lens or a variable lens which allows the wave front curvature of the emerging beam to be tuned. If the power of the lens 71 is rapidly tuneable using known technologies such as liquid crystal lenses, the HMD unit would be able to manipulate focus cues of image with potentials of displaying volumetric images. This system may provide improved image quality compared to a laser based system as LEDs do not suffer from speckles. Using a broadband LED could also reduce artifacts caused by thin film interference within various optics of the HMD device.

### 8^{th} Embodiment

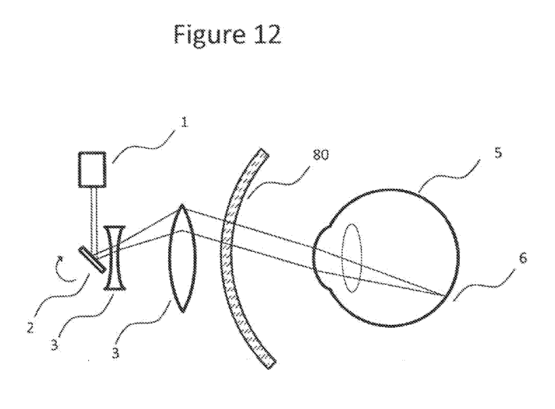

FIG. 12 shows the eighth embodiment, wherein the SLM 80 is curved. Liquid crystal based SLMs may not achieve ideal performance when light is incident at large angles from the SLM's surface normal. Using an SLM that curves towards the eye could reduce this angle of incidence. Hence this embodiment could improve the image quality of the HMD.

### 9^{th} Embodiment

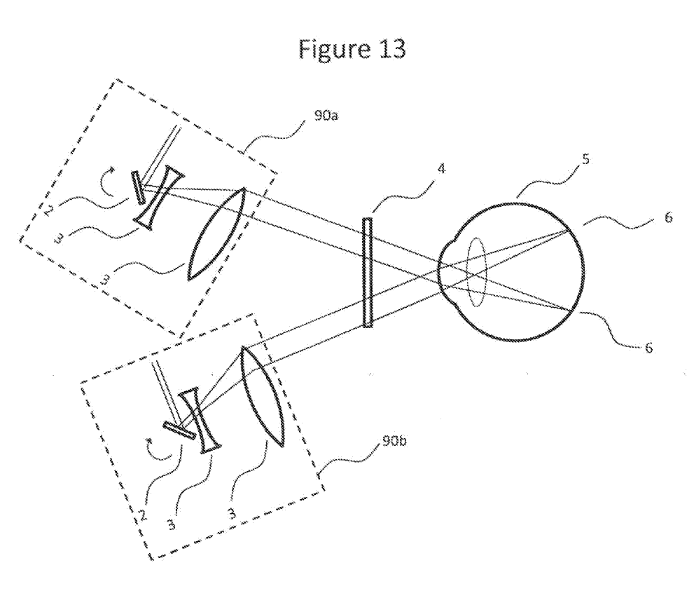

FIG. 13 shows the ninth embodiment, wherein multiple laser scanners 90a-b are used to increase the FoV and resolution of the HMD display. Depending on the exact geometry of the HMD, the laser scanners could either share one SLM 4 as depicted in the figure, or have a separate SLM for each laser scanner.

### 10^{th} Embodiment

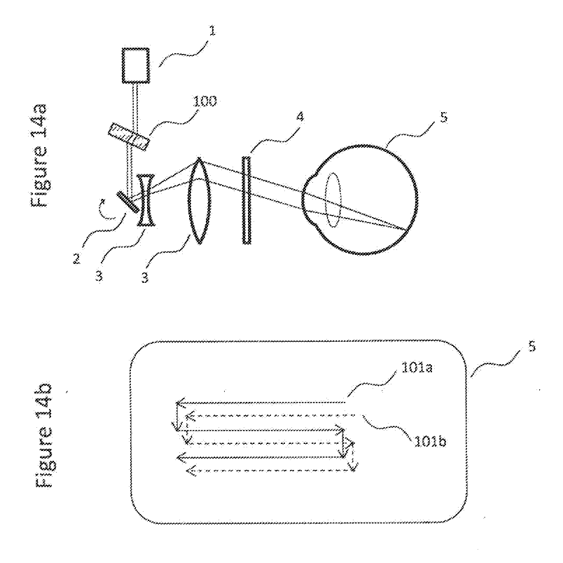

FIG. 14a-b shows the tenth embodiment, where the effective resolution of the HMD is increased by including a dithering component that introduces dithering to the laser scan lines on the retina. One method to achieve this is depicted in FIG. 14a, where another SLM or a switchable optical retarder 100 is placed along the laser beam path as the dithering component. Changing the optical thickness of the retarder displaces the laser beam (by for example changing the polarization of the incident beam 1 by means of a ferroelectric LC cell and polarizer, not shown), meaning the image on the retina is also displaced slightly. By synchronising the optical retardation with the MEMS scanner, it is possible to produce laser scan lines offset by sub-pixel distances on the retina 5 as shown in FIG. 14b. By interlacing multiple frames with varying sub-pixel displacement 101a-b (including scanning lines in odds frames 101a and scanning lines in even frames 101b), the user would be able to perceive resolution higher than the native resolution of the laser scanner.

An aspect of the invention, therefore, is a wearable device. In exemplary embodiments, the wearable device includes a light source, and a display unit including an image engine that controls the light source to generate image content for display, and a plurality of optical elements configured to direct the image content into a viewing zone. An eye monitor measures information pertaining to an eye configuration of a user wearing the wearable device, wherein the image content is visible to the user when the eye is aligned with respect to the viewing zone. A spatial light modulator (SLM) is configured to move a position of the viewing zone based on the eye configuration information measured by the eye monitor. The wearable device may include one or more of the following features, either individually or in combination.

In an exemplary embodiment of the wearable device, the eye monitor is configured to measure pupil size of the user, and the optical elements are configured to direct the image content into the viewing zone that is smaller in at least one dimension than twice the measured pupil size.

In an exemplary embodiment of the wearable device, the light source includes a micro-electro-mechanical systems (MEMS) scanning mirror.

In an exemplary embodiment of the wearable device, the wearable device further includes axicon optics positioned between the light source and the MEMS scanning mirror that generates a non-diffracting zone to limit diffraction from the MEMS scanning mirror.

In an exemplary embodiment of the wearable device, the (SLM) comprises a pixilated liquid crystal panel.

In an exemplary embodiment of the wearable device, the eye monitor comprises a gaze tracker that is configured to measure gaze direction, pupil diameter, and distance of the eye from the SLM as included in the eye configuration information.

In an exemplary embodiment of the wearable device, the gaze tracker is configured to determine an error value of eye tracking as included in the eye configuration information.

In an exemplary embodiment of the wearable device, the plurality of optical elements includes a lens array including a plurality of lenslets, and each lenslet in the lens array directs the image content into a separate eyepoint corresponding to a respective viewing zone.

In an exemplary embodiment of the wearable device, the SLM is configured to move one or more of the eyepoints and/or vary separation of the eyepoints based on the eye configuration information measured by the eye monitor.

In an exemplary embodiment of the wearable device, the image engine comprises a pixilated image display panel.

In an exemplary embodiment of the wearable device, the SLM is configured to change the position of the viewing zone relative to the image display panel based on the eye configuration information measured by the eye monitor.

In an exemplary embodiment of the wearable device, the SLM is switchable between different amplitude and/or phase patterns to create multiple eyepoints that each correspond to a respective viewing zone, and the SLM is switched to move one or more of the eyepoints and/or vary separation of the eyepoints based on the eye configuration information measured by the eye monitor.

In an exemplary embodiment of the wearable device, the light source comprises an LED light source and a collimating lens that collimates light emitted by the LED light source.

In an exemplary embodiment of the wearable device, the SLM is curved.

In an exemplary embodiment of the wearable device, the light source comprises a plurality of laser scanners that directs light onto a single SLM.

In an exemplary embodiment of the wearable device, the light source comprises a plurality of laser scanners that each directs light onto a respective SLM.

In an exemplary embodiment of the wearable device, the wearable device further include a dithering component placed in a path of light from the light source to produce laser scan lines.

In an exemplary embodiment of the wearable device, the dithering component is one of an optical retarder or another SLM.

In an exemplary embodiment of the wearable device, the wearable device includes: a light source; a micro-electro-mechanical systems (MEMS) scanning mirror that rasterizes a light beam from the light source in one dimension; a diffractive element that diverges the light beam coplanar to a rotating axis of the MEMS scanning mirror and a direction of propagation of the light beam; an astigmatic optics; an image panel, wherein the astigmatic optics directs the light beam onto the image panel, the image panel comprising an image engine that generates image content for display; an eye monitor that measures information pertaining to an eye configuration of a user wearing the wearable device, wherein the image content is visible to the user when the eye is aligned with respect to the viewing zone; and a spatial light modulator (SLM) that receives the image content from the image panel and is configured to move a position of the viewing zone based on the eye configuration information measured by the eye monitor.

In an exemplary embodiment of the wearable device, the eye monitor is configured to measure pupil size of the user, the image displayed on the image panel is synchronized with a scan angle of the MEMS scanning mirror, and the SLM is configured to generate a rectangular viewing zone that is smaller than twice the measured pupil size in at least one dimension.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

Industrial application will be mainly for wearable displays, in particular for achieving light weight Head Mounted Displays (HMD). The principal advantage of using spatial light modulators to steer the viewing zone of HMDs is the elimination of large relay optics and large moving parts, thereby further reducing the device's weight, increasing its durability, and improving user comfort. Furthermore, the use of SLM to steer the viewing zone of HMDs allow the pupil to be moved in 3D space, making the device to be more versatile for fitting head shapes of different people under different environments and image contents.

Hardware manufactured using this invention may be useful in the fields of virtual reality (VR) and augmented reality (AR) for both consumer and professional markets. HMD manufactured by this invention could have applications including everyday use, gaming, entertainment, task support, medical, industrial design, navigation, transport, translation, education, and training.

1. A wearable device comprising:
a light source;
a display unit including an image engine that controls the light source to generate image content for display, and a plurality of optical elements configured to direct the image content into a viewing zone;
an eye monitor that measures information pertaining to an eye configuration of a user wearing the wearable device, wherein the image content is visible to the user when the eye is aligned with respect to the viewing zone; and
a spatial light modulator (SLM) that is configured to move a position of the viewing zone based on the eye configuration information measured by the eye monitor.

2. The wearable device of claim 1, wherein the eye monitor is configured to measure pupil size of the user, and the optical elements are configured to direct the image content into the viewing zone that is smaller in at least one dimension than twice the measured pupil size.

3. The wearable device of claim 1, wherein the light source includes a micro-electro-mechanical systems (MEMS) scanning mirror.

4. The wearable device of claim 3, further comprising axicon optics positioned between the light source and the MEMS scanning mirror that generates a non-diffracting zone to limit diffraction from the MEMS scanning mirror.

5. The wearable device of claim 1, wherein the (SLM) comprises a pixilated liquid crystal panel.

6. The wearable device of claim 1, wherein the eye monitor comprises a gaze tracker that is configured to measure gaze direction, pupil diameter, and distance of the eye from the SLM as included in the eye configuration information.

7. The wearable device of claim 6, wherein the gaze tracker is configured to determine an error value of eye tracking as included in the eye configuration information.

8. The wearable device of claim 1, wherein the plurality of optical elements includes a lens array including a plurality of lenslets, and each lenslet in the lens array directs the image content into a separate eyepoint corresponding to a respective viewing zone.

9. The wearable device of claim 8, wherein the SLM is configured to move one or more of the eyepoints and/or vary separation of the eyepoints based on the eye configuration information measured by the eye monitor.

10. The wearable device of claim 1, wherein the image engine comprises a pixilated image display panel.

11. The wearable device of claim 10, wherein the SLM is configured to change the position of the viewing zone relative to the image display panel based on the eye configuration information measured by the eye monitor.

12. The wearable device of claim 1, wherein the SLM is switchable between different amplitude and/or phase patterns to create multiple eyepoints that each correspond to a respective viewing zone, and the SLM is switched to move one or more of the eyepoints and/or vary separation of the eyepoints based on the eye configuration information measured by the eye monitor.

13. The wearable device of claim 1, wherein the light source comprises an LED light source and a collimating lens that collimates light emitted by the LED light source.

14. The wearable device claim 1, wherein the SLM is curved.

15. The wearable device of claim 1, wherein the light source comprises a plurality of laser scanners that directs light onto a single SLM.

16. The wearable device of claim 1, wherein the light source comprises a plurality of laser scanners that each directs light onto a respective SLM.

17. The wearable device of claim 1, further comprising a dithering component placed in a path of light from the light source to produce laser scan lines.

18. The wearable device of claim 17, wherein the dithering component is one of an optical retarder or another SLM.

19. A wearable device comprising:
a light source;
a micro-electro-mechanical systems (MEMS) scanning mirror that rasterizes a light beam from the light source in one dimension;
a diffractive element that diverges the light beam coplanar to a rotating axis of the MEMS scanning mirror and a direction of propagation of the light beam;
an astigmatic optics;
an image panel, wherein the astigmatic optics directs the light beam onto the image panel, the image panel comprising an image engine that generates image content for display;
an eye monitor that measures information pertaining to an eye configuration of a user wearing the wearable device, wherein the image content is visible to the user when the eye is aligned with respect to the viewing zone; and
a spatial light modulator (SLM) that receives the image content from the image panel and is configured to move a position of the viewing zone based on the eye configuration information measured by the eye monitor.

20. The wearable device of claim 19, wherein the eye monitor is configured to measure pupil size of the user, the image displayed on the image panel is synchronized with a scan angle of the MEMS scanning mirror, and the SLM is configured to generate a rectangular viewing zone that is smaller than twice the measured pupil size in at least one dimension.
